(19) United States
(12) Patent Application Publication
(10) Pub. No.: US 2014/0125462 A1
(43) Pub. Date: May 8, 2014

(54) SYSTEM AND METHOD FOR PROVIDING INFORMATION ABOUT AN OBJECT

(71) Applicant: BMF MainStreet America, LLC, Spring, TX (US)

(72) Inventors: Michael FEIGIN, The Woodlands, TX (US); Jose BLANCO, Spring, TX (US)

(73) Assignee: BMF MainStreet America, LLC, Spring, TX (US)

(21) Appl. No.: 14/073,424

(22) Filed: Nov. 6, 2013

Related U.S. Application Data
(60) Provisional application No. 61/723,126, filed on Nov. 6, 2012.

(51) Int. Cl. G06K 7/10

(52) U.S. Cl. CPC G06K 7/10386
USPC 340/10.6

(57) ABSTRACT

A system and method for providing information about an object. In one embodiment, a system includes a hand held device and a wireless radio frequency (RF) tag. The hand held device is wirelessly coupled to a central computer system, and includes a wireless radio frequency (RF) tag reader, and a display panel. The wireless RF tag is attached to an object offered for sale, and includes an identifier for the object. The hand held device is configured to: wirelessly scan the wireless tag; to extract the identifier from information wirelessly received from the wireless tag via the wireless scan; to wirelessly communicate the identifier to the central computer system as part of a request for information concerning the object; and upon receiving a response to the request for information, to display the information concerning the object via the display panel.

### CROSS REFERENCE TO RELATED APPLICATIONS

This application claims priority to U.S. Provisional Application Ser. No. 61/723,126, filed on Nov. 6, 2012, and entitled “A METHOD AND SYSTEM FOR SCANNING PRODUCT TAGS WITH A HAND HELD DEVICE TO LEARN ABOUT AND PURCHASE THE PRODUCT”, which is incorporated herein by reference in its entirety.

### BACKGROUND

In a consumer society, numerous examples exist of environments in which consumers should be provided with information is needed to facilitate purchasing decisions. For example, businesses that sell consumer electronics typically offer numerous products for sale and each product has its own specifications and price that should be provided to the consumer as part of an informed purchasing process. Other examples exist as well of this information dissemination problem. For example, in home remodeling and/or new home construction, consumers generally have many questions about types of home designs, building materials (e.g., brick versus siding), interior and exterior finishes, furniture, appliances, etc.

Beyond the purchasing context, museums and other institutions also have a need for efficient dissemination of information to visitors. For example, museums provide access to numerous art objects, each object being associated with a great deal of information of interest to museum visitors.

### SUMMARY

A system and method for providing information about an object and facilitating product purchase are disclosed herein. In one embodiment, a system for providing information about an object includes a hand held device and a wireless radio frequency (RF) tag. The hand held device is wirelessly coupled to a central computer system, and includes a wireless radio frequency (RF) tag reader, and a display panel. The wireless RF tag is attached to an object offered for sale, and includes an identifier for the object. The hand held device is configured to: wirelessly scan the wireless tag; to extract the identifier from information wirelessly received from the wireless tag via the wireless scan; to wirelessly communicate the identifier to the central computer system as part of a request for information concerning the object; and upon receiving a response to the request for information, to display the information concerning the object via the display panel.

In another embodiment, method for providing information includes 1) attaching a wireless radio frequency (RF) tag to each of a plurality of objects; 2) scanning the wireless tag of one of the objects with a first hand held wireless device; 3) extracting an identifier from information received from the wireless tag via the scanning; 4) transmitting the identifier to a central computer system; 5) retrieving, in the central computer system, specifications of the one of the objects; 6) transmitting the specifications to the hand held wireless device; and 7) presenting the specifications for viewing on the hand held wireless device.

In a further embodiment, a non-transitory computer-readable medium encoded with instructions that when executed cause a processor to: 1) associate each of a plurality of objects with a wireless radio frequency tag attached to the object; 2) associate a geographic location of each of the objects with an identifier of the wireless tag attached to the object; 3) receive wireless tag identifiers from a hand held wireless device that scans the wireless tags; and 4) determine a location of the hand held device based on the geographic location associated with a wireless tag last scanned by the hand held device based on the wireless tag last scanned being scanned by the hand held device not more than a predetermined time prior to location determination.

### BRIEF DESCRIPTION OF THE DRAWINGS

For a detailed description of exemplary embodiments of the invention, reference will now be made to the accompanying drawings in which:

FIG. 1 shows a block diagram of a information dissemination system in accordance with principles disclosed herein;

FIG. 2 shows a diagram of an illustrative portable electronic device suitable for use in an information dissemination system in accordance with principles disclosed herein;

FIG. 3 shows a block diagram of an illustrative portable electronic device suitable for use in an information dissemination system in accordance with principles disclosed herein;

FIG. 4 shows an illustrative table for associating users with respective portable electronic devices in an information dissemination system in accordance with principles disclosed herein;

FIG. 5 shows an illustrative table for associating a tag identifier with a range of other information in accordance with principles disclosed herein;

FIG. 6 shows an arrangement of show homes that include information dissemination tags in accordance with principles disclosed herein;

FIG. 7 shows a diagram of a show home including information dissemination tags attached to each object included in the show home in accordance with principles disclosed herein; and

FIG. 8 shows a flow diagram for a method for providing information in accordance with principles disclosed herein.

### NOTATION AND NOMENCLATURE

In the following discussion and in the claims, the terms “including” and “comprising” are used in an open-ended fashion, and thus should be interpreted to mean “including, but not limited to . . . .” In addition, the term “couple” or “couples” is intended to mean either an indirect or a direct connection. Thus, if a first device couples to a second device, that connection may be through a direct connection, or through an indirect connection accomplished via other devices and connections. Further, the term “software” includes any executable code capable of running on a processor, regardless of the media used to store the software. Thus, code stored in memory (e.g., non-volatile memory), and sometimes referred to as “embedded firmware,” is included within the definition of software. The recitation “based on” is intended to mean “based at least in part on.” Therefore, if X is based on Y, X may be based on Y and any number of other factors.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In conventional shopping contexts, service representatives and/or signage are employed to provide information to the consumer. However, sales personnel may not be able to meet the demand for information dissemination during periods of heavy traffic through the store. Lack of sufficient sales personnel to provide needed information may be frustrating to customers. And even if a service representative is available to the customer, the representative may not be able to answer all of the customer's questions about the products of interest to that customer. Signage may be subject to high initial costs and/or high modification costs when product information changes. Further, signage may detract from and/or interfere with the aesthetics of product displays.

Embodiments of the present disclosure address this information dissemination problem via a computer-based system that equips each user (e.g., customer) with a portable electronic device (PED). The user registers himself with a service and is assigned a particular PED to use while browsing a facility (a store, a home remodeling/construction site, a museum, etc.). The PED is equipped with a short range wireless tag reader. A unique tag is placed on each object of interest in the facility. As the user moves his PED within wireless range of a tag, the PED's tag reader scans the tag and is provided with information about the object on which the tag is located. The information is provided to the user of the PED through the PED. The information may include specific details regarding the object, purchase price, advertisements for accessories, installation information, etc. The user can scan tags of multiple objects in the facility and thus be presented with information on any object of interest.

For facilities in which objects are for sale to the user, the user of the PED can scan the object's tag into a “shopping cart” assigned to the user during a registration process. Tag information also can be stored by the user of the PED in a project list for future review and analysis by the user. A project list may be similar to a “wish list” in that items included in the project list have been identified by the user as of special interest. The user, after reviewing and analyzing items in the project list, may move those items to the “shopping cart,” edit the quantities, or delete the items all together. These and other capabilities of various embodiments are described herein.

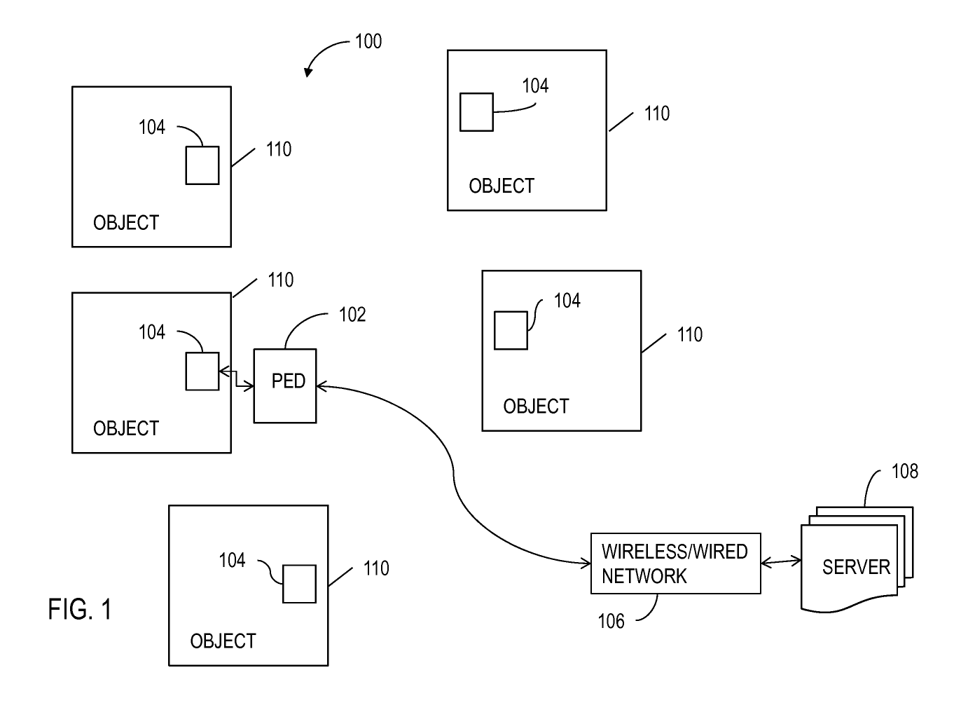

FIG. 1 shows a block diagram of an information dissemination system 100 in accordance with principles disclosed herein. The system 100 includes a plurality of tag devices 104, a PED 102, and one or more servers 108. The tag device 104 may be a radio frequency identification (RFID) integrated circuit, a near field communication (NFC) device, or any other type of wireless tag. Each of the tag devices 104 is attached to an object 110. An object 110 may be an item for which information may be presented via the PED 102. For example, an object 110 may an item offered for sale, and information concerning specifications, price, etc. of the object 110 may be presented via the PED 102. The PED 102 is a hand held portable wireless communication device that wirelessly communicates with the tag devices 104. In some embodiments, the communication range between the PED 102 and a tag device 104 is less than about 4 inches. Thus, the PED 102 can scan a tag device 104 when the PED is brought to within about 4 inches of the tag device 104 attached to the object 110.

The objects 110 that are tagged can be any type of object. For example, in a consumer electronics store, the objects 110 may be consumer electronic devices (e.g., televisions, computers, printers, etc.). As disclosed herein, information related to the object 110 on which a tag device 104 is located is presented via the PED 102.

The server 108 is a computer device that communicates with the PED 102 via a network 106. The network 106 may include a wireless network, such as a wireless local area network (WLAN). The network 106 may also include a wired local area network. In some embodiments, when a PED 102 scans a tag device 104, the PED 102 transmits a message to the server 108 via the network 106, and the server 108 may reply to the message with a response the provides information about the object 110 to which the tag device 104 is attached. The PED 102 can display or otherwise present the information received from the server 108. The server 108 may be embodied in a computer, e.g., a rackmount computer, desktop computer, etc., as known in the art. Accordingly, the server 108 includes processor(s) and software instructions that can be executed by the processor(s) to realize the functionality disclosed herein.

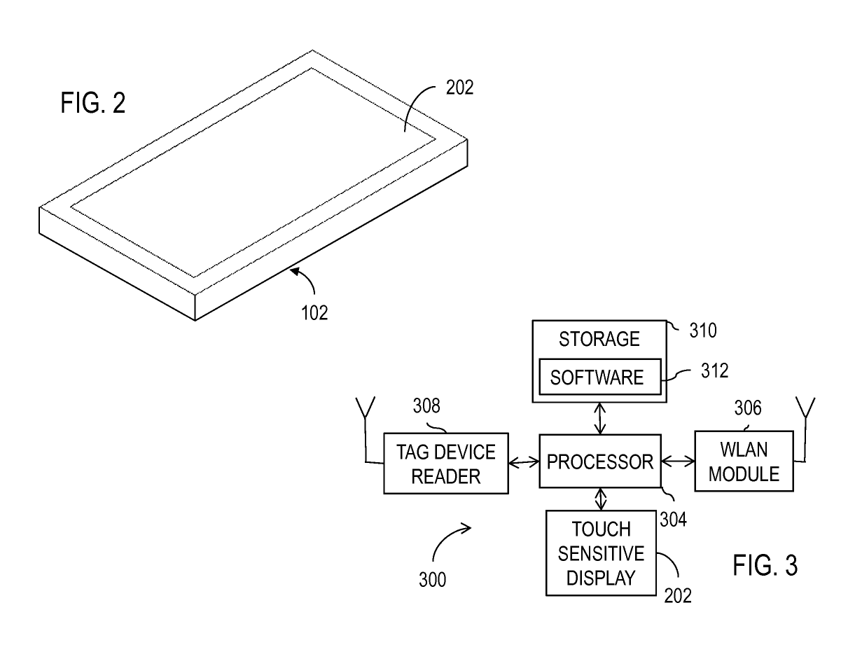

FIG. 2 shows a diagram of an illustrative PED 102 suitable for use in the information dissemination system 100. The PED 102 preferably is a handheld, battery operated computing device that includes a touch sensitive display 202. In some embodiments, the PED 102 may be embodied in a tablet computer, a personal digital assistant (PDA), or other handheld portable computing device.

FIG. 3 shows a block diagram of an illustrative PED 102. The PED 102 includes a processor 304, storage 310, a touch sensitive display 202, a WLAN module 306, and a tag device reader 308. The processor 304 is coupled to the touch sensitive display 202, the WLAN module 306, and the tag device reader 308.

The processor 304 may include a general-purpose microprocessor, a digital signal processor, a microcontroller, or other devices capable of executing instructions retrieved from a computer-readable storage medium. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems.

The storage 310 is a non-transitory computer-readable storage medium suitable for storing instructions to be executed by the processor 304. The storage 310 may include volatile storage such as random access memory, non-volatile storage (e.g., a hard drive, an optical storage device (e.g., CD or DVD), FLASH storage, read-only-memory), or combinations thereof. The storage 310 includes software 312 which is executable by the processor 304 and provides the PED 102 with some or all of the functionality described herein as attributable to the PED 102.

The tag device reader 308 wirelessly communicates with the tag devices 104, and may be an RFID reader, an NFC reader or other suitable type of short range wireless reader, such as a barcode reader.

The touch sensitive display 302 provides a user interface through which a user interacts with the PED 102. Via the touch sensitive display 102, a user may view information regarding an object 110 upon scanning a tag device 104 as well as request various functions to be performed such as moving an identifier for a tagged object 110 into a shopping cart or project list associated with the PED 102.

In addition to scanning tag devices 104, and providing information regarding the object 110 to which the tag device 104 is attached, the software 312, when executed by the processor 304 may allow the PED 102 to provide interactive navigation of the premises/store/showroom where the tag device 104 is located. For example, each PED 102 may include an interactive map of the premises so that users may take a virtual tour before physically browsing a store or showroom, or at any other time. When taking a virtual tour of the premises, the PED 102 may provide the ability to determine (e.g., view) objects 110 contained in every area and to view details of an object 110 as if the tag device 104 attached to the object 110 had been scanned.

The software 312, when executed by the processor 304 may also allow the PED 102 to provide calendar information for events scheduled to take place at a facility. For example, if an establishment provides tutorials and/or demonstrations regarding products, the PED 102 can inform the user of the calendar of events for that day, the details of each event, and the number of seats available. The user can then reserve a seat or seats for a desired event or events, via the PED 102, and the PED 102 may prompt the user with a reminder shortly before the event is scheduled to begin.

The software 312 may also include instructions that allow the PED 102 to contact and/or summon service representatives for assistance. The PED 102 may provide options regarding how a user receives assistance from service representative. For example, via the PED 102, a user may request to speak with a service representative in person. In this instance, the service representative may be able to locate the PED user via a PED location system as disclosed herein. The user may also be able to communicate with a service representative via the PED 102. Such communication may be via voice, video, and/or text. The voice, video, and/or textual communication may also be provided to allow communication between users of PEDs 102 linked to form a group.

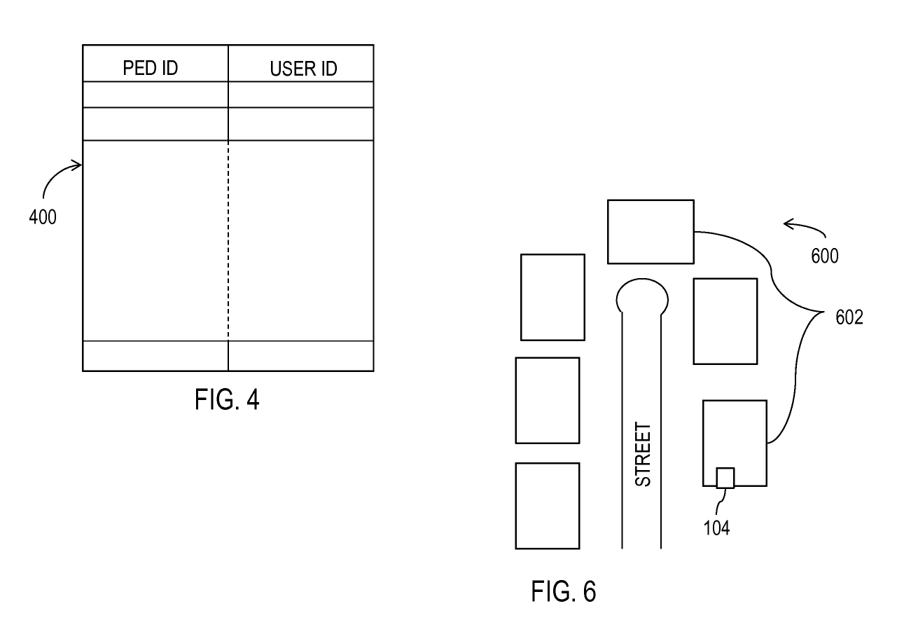

A unique identification number may be associated with each PED 102, and each PED 102 may be uniquely associated with a user. FIG. 4 shows an illustrative table 400 for associating users with respective PEDs 102 in the system 100. Additionally, the table 400 may include a field or value that links multiple PEDs 102 and users together and allows for linked users to interact (e.g., communicate) with one another through their linked PEDs 102. In some embodiments, the table 400 may be stored in the server 800.

When multiple PEDs 102 are grouped or associated (i.e., linked), the PEDs 102 may provide added functionality, for example, with regard to the shopping carts and project lists associated with each PED 102 of a group. Each grouped PED 102 may provide the ability to select and view the shopping cart and/or project list and/or event list maintained via each other PED 102 of the group. The grouped PEDs 102 may also provide a “back” function that allows the user to move back one screen to select another view of the other PED's lists. For example, if user A selects to view user B's lists, user A may choose to first view user B's project list. After viewing the project list, user A may go back one screen to then select to view user B's scheduled events. When user A is finished viewing user B's lists, user A may either go back multiple times to get to user A's PED home screen or user A may select a home icon to go directly to user B's home screen. In another example, users shopping together, but in different areas, may monitor each other's lists for ideas or to ensure they do not select identical objects 110. The PED may also provide communication between the users when shopping separately.

In addition to the viewing lists by PEDs 102 of a group, the PED 102 may allow a user to pull items from a list (e.g., shopping cart, project list, event list) of a grouped PED 102 and add the item a list maintained by the PED 102. The list of the associated PED 102 from which the item is copied may be unaltered by the copying operation. Thus, lists of associated PEDs 102 may be aggregated or combined by copying. Each PED 102 may enable or disable viewing and/or copying of lists and items contained in a list by an associated PED 102.

In addition to inter-user communication, the system 100 provides communication between PED users and customer service representatives and other service providers of the PED issuing institution. For example, if the institution offers dining services, then the PED 102 may include menus of the restaurant(s) located at the institution. The PED 102 may also allow the user to place a food order and pay for the ordered food using a credit card associated with the PED 102. Upon placing an order, the user may be given a unique ID to use when picking up the food. Alternatively, the PED 102 may serve as a unique ID when picking up the food by scanning the PED 102 at the food pick-up location. The PED 102 may further allow the user to make dining reservations and to select a specific table, pre-order food items, etc. during the reservation process.

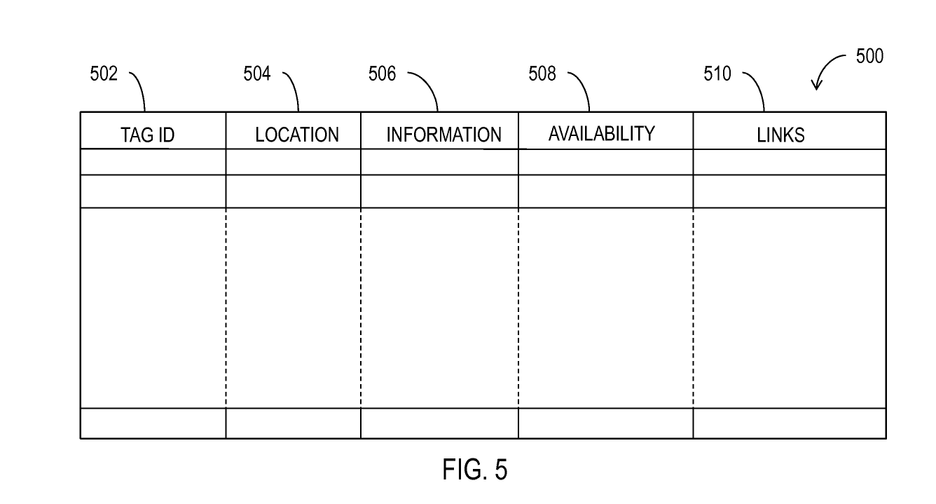

FIG. 5 shows an illustrative table 500 for associating a tag identifier with a range of other information in accordance with principles disclosed herein. The table 500, or multiple instances of the table 500, preferably includes a row corresponding to each tagged object 110 located in a facility (e.g., a store or showroom) with each object 110 associated with a unique tag ID 502. When a user scans a tagged object 110 with a PED 102, the PED's WLAN module 306 preferably transmits a retrieval message to the server 108. The transmitted message may contain a tag ID value and a user ID value, a time stamp value, and/or a PED ID value. The server 108 may apply the tag ID contained in the message to search for the received tag ID in the table 500. Upon finding the associated row for the item (i.e., the row for the tag ID value), server 108 may transmit the data contained in each column of table 500 or a subset of the column regarding the tagged object 110 back to the PED 102 that originated the retrieval message. The PED 102 may then display a written description of the tagged object along with graphics and icons for audio and video regarding the object. Via headphones or a speaker included in the PED 102, the PED 102 may present audio information related to the object 110. The table 500 may be stored in the server 108.

The table 500 includes a list of tag ID values 502, the location 504 of each tagged object 110, information 506 for each tagged object 110, availability 508 of the object 110, and links 510. Information 506 may include either information (e.g., specifications) for the tagged object 110, links or pathways to such information, or a combination of the two. The table 500 may be expandable to include other information as necessary and in no way should be limited to the columns presented in FIG. 5.

Alternatively, the PED 102 may contain some or all of the information regarding the scanned object in storage 310 and retrieve this information once a tag device 104 attached to an object 110 is scanned. In another embodiment, the tag device 104 may contain the information regarding the object 110 and the PED 102 may receive the data from the tag device 104 upon scanning. In yet another implementation, the PED may utilize a combination of such techniques to receive and display information regarding the object 110.

The availability field 508 includes information specifying whether an object 110 is available for sale. For example, information associated with the availability field may inform the PED 102 of whether the scanned object 110 is one that is sold by the store or showroom and, if it is sold, the number remaining in stock. A value of availability 508 may similarly inform PED 102 that the scanned object 110 is not available and the PED 102 may then display for the user other avenues for purchasing the object, e.g., other local stores, websites, etc. In an instance when the scanned object 110 represents a service and not a product, the PED 102 may inform the user of whom to speak with regard to service details. Lastly, links 510 include information for informing the PED 102 and user of potential web-based resources that may be accessed by the PED 102 for additional information on the object 110, the manufacturer of the object 110, or the service.

The system 100 also provides PED 102 locating capabilities. For example, a PED 102, and the user thereof, may need to be located, in a large area which may include multiple structures. In the system 100, the WLAN data (e.g., received signal strength data), or the PED 102 scanning data may be used to locate a PED 102 and the user thereof. The tables 400 and 500 associate each PED 102 with a user, and associate each tagged object 110 with a physical location. Accordingly, the server 108 may use the information in tables 400 and 500 in conjunction with the scanning history of PED 102, and possibly in conjunction with the WLAN data, to locate the user and/or PED 102.

During use of the PED 102, for each tag device 104 scanned by a PED 102, the server 108 records the associated PED ID and tag ID provided by the PED 102. The server 108 may also record a time stamp for each scan operation. To locate a PED 102, the server 108 references the scanning data for the PED 102 and the locations of the scanned items to determine a probable location of the PED 102. If last received scanning information provided by a PED 102 is fresh (e.g., received with a predetermined interval (e.g., 30 seconds) prior to the location request), then the PED 102 is likely within the vicinity of the last scanned tag device 104, and the location of the last scanned tag device 104 may be deemed the location of the PED 102.

If the last scanning event of a PED 102 is stale (e.g., outside of the predetermined time interval), then the WLAN system may be used to locate the PED 102 and its user. In one embodiment, the WLAN system may be used to triangulate the position of the PED 102 using the strength of signal received from the PED 102 at multiple WLAN access points. The server 108 may keep logs of the communications taking place between the PED 102 and the server 108 and these logs may include which access points are used by the PED 102 to wirelessly communicate with the server 108 and the received signal strengths. These logs may also be time stamped so that the last time the PED 102 gained access to the server 108 may be determined. The location of the access points used for the last communication may be used to triangulate the location of PED 102 and user.

Some embodiments of the PED 102 include software instructions that are executable by the processor 304 to provide functionality directed to service representatives. Such PEDs 102 may be denoted as master or control PEDs. Such embodiments of the PED 102 may allow service representatives to access a PED user's account information, profile, shopping cart, and project list. If there are multiple users associated into a group, a control PED 102 may allow a service representative to view all associated user's information and consolidate shopping carts and project lists. The PED 102 may allow the service representative to accept payments for the items in a user's shopping cart using a credit card reader coupled to the PED 102. The PED 102 may also allow a service representative, while taking payment from a user, to add a shipping address to a user's profile for items requiring delivery or that are on back order.

During interaction between a service representative and a user, the PED 102 may allow the service representative to view and manipulate the user's profile. If the service representative and the user are interacting face-to-face, the service representative may be able to scan the user's PED 102 with the reader 308 of the control PED 102, obtain a user ID associated with the PED 102 of the user from the server 108, and use the user ID to access the user's profile stored in the server 108. The profile may contain the user's account information, project lists and shopping cart.

When contacted by a user, the PED 102 of a service representative may display the user's name and a link to their profile. The PED 102 may also allow a service representative to search the server 108 for a user's profile using the user's user ID, phone number, email address, etc., as search key.

After accessed the user's profile, the PED 102 may allow the service representative to edit all of the user's information (e.g., the user's physical address, email address, credit card information, etc.). If the battery of a user's PED 102 is drained, then the PED 102 allows the service representative to activate another PED 102 for the user and associate the new PED 102 with the user's profile while maintaining links between the user ID and PED ID in the server 108. The PED 102 may further allow a service representative to associate a group of users and their PEDs from a control PED 102.

While the service representative has access to a user's profile, the PED 102 may allow the service representative to modify the user's shopping cart and/or project list. The service representative may be able to edit a quantity of items in either list and add items to either list. The control PED 102 may also inform the service representative of potential upsells to relay to the user. The upsells will be based on items currently in the user's shopping cart and project list. If the user decides on an upsell item, the service representative may then be able to change the user's shopping cart, via the PED 102, to either replace the item in the cart with the upsell item or include the upsell item in addition to the items already in the shopping cart.

When users are associated, the PED 102 may allow a service representative to view the profiles of all of the associated users. The PED 102 may present the profiles serially, but also may present the shopping carts of the associated users simultaneously. In some embodiments, the service representative may be able to edit and add to each user's shopping cart and project list. In some embodiments, the PED 102 may allow the service representative to consolidate the shopping carts of a selected group of associated users.

Embodiments of the system 100 may be applied in a variety of contexts. For example, the system 100 may be applied to advantage in the context of home construction and remodeling. FIG. 6 depicts a showcase 600 of multiple homes 602 that apply the system 100 to provide information related to home remodeling, new home construction, and related services to consumers browsing the showcase 600. In the showcase 600 of multiple homes 602, tag devices 104 may be attached to objects in the homes 602, the homes 602, etc. As a consumer browses through the homes 602, a PED 102 issued to the consumer may provide information regarding each object attached to a scanned tag device 104.

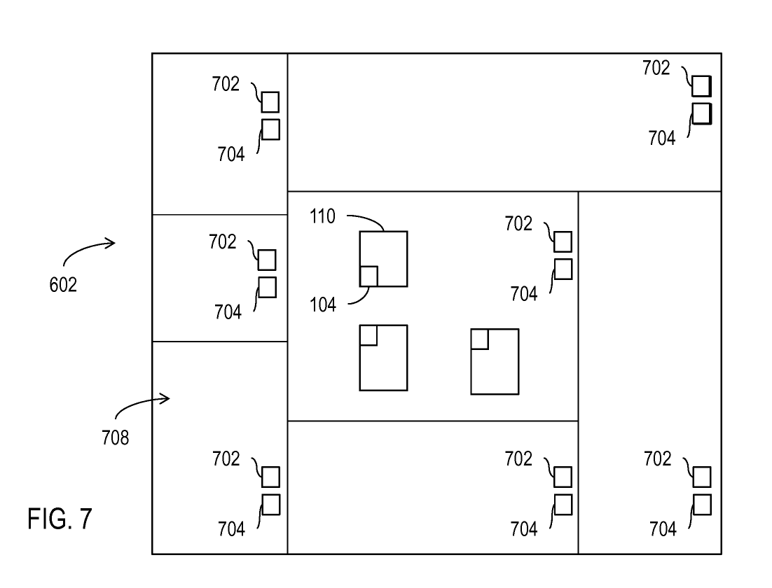

FIG. 7 shows a diagram of a show home 602 including a tag device 104 attached to each object 110 included in the show home 602. The objects 110 included in the show home 602 may include furniture, appliances, electronics, etc. In addition to each object 110 including a tag device 104. Each room 708 in the show home 602 may include a tag device 702 that can be accessed to provide information about the room in general (e.g., colors, materials, dimensions, etc.). Furthermore, tag devices 704 may be provided to represent a group of products or finishings within a room 708. For example, all furnishings in a room may be associated with a single tag device 704.

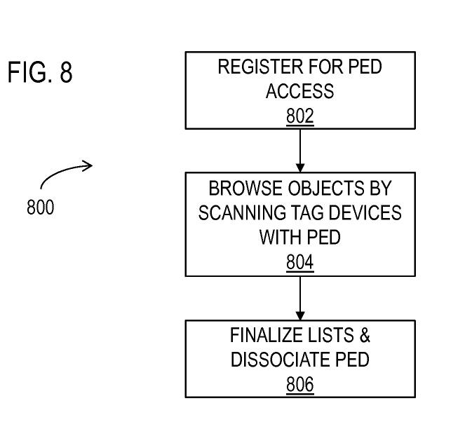

FIG. 8 shows a flow diagram for a method 800 for providing information in accordance with principles disclosed herein. Though depicted sequentially as a matter of convenience, at least some of the actions shown can be performed in a different order and/or performed in parallel. Additionally, some embodiments may perform only some of the actions shown. In some embodiments, at least some of the operations of the method 800 may be provided by a processor executing instructions stored in a computer-readable memory device.

In block 802, the owner or operator of a facility containing tagged objects 110 requires users to complete a registration process before using a PED 102 to scan tagged objects 110. The registration process may include, for example, the completion of an electronic form (via a computer) to input demographic information of the user such as name, address, driver's license number, etc. After the user is registered, a PED 102 is assigned to the user. Each PED 102 preferably includes a unique PED identifier (PED ID) that differentiates the PED 102 from each other PED 102 as shown in the table 400.

Alternatively, the registration process may begin when a user purchases a ticket. Each ticket received by the user may entitle the user to receive one PED 102, with each PED 102 associated with a different user. Associating each PED 102 with a different user allows each user to tailor their shopping experience and to scan only the items they are interested in learning about or purchasing. The user may take their ticket to a counter where an identification card, preferably a driver's license, is scanned or the user's information is manually entered into the central computer system e.g., server 108. Once the user's information is entered, the user is assigned a PED 102 and the PED 102 is associated with the user in the central computer system.

In some embodiments, after issuance of a PED 102 to a user, the user may then use the PED 102 to input additional information, i.e., a credit card number, email address, and other demographic information. The user may not be able to take advantage of all the functionality of the PED 102 without providing at least an email address.

The registration process uses the user's email address, or another unique identifier, to create a profile in the central system. The system profile associates a PED ID with the user ID and may generate several files associated with that user. The user ID may be an email address, a driver's license number or a random identifier chosen by the central system. Files associated with a user may include a shopping cart, a project list, and/or a list of events the user has calendared to attend.

A group of related users (e.g., a family, friends) may be associated or grouped with each other, if desired, during the registration process. The association includes electronically associating, in the central system, the PED IDs of each PED 102 assigned to a user in the group. The central system may either create a separate table of the associated PED IDs and user IDs or the central system may mark the PED IDs and user IDs with an extra identifier so that their association is noted. Associating PEDs 102 as a group may allow the users to interact with each other's shopping carts, project lists, and communicate with one another through their PEDs 102.

In block 804, the user is browsing the facility (e.g., store or other establishment), and using the PED 102 to scan tag devices 104 attached to objects 110 of interest to the user. Upon scanning an object's tag device 104, the PED 102 retrieves identification information from the tag device 104, and transmits the identification information to the central computer system. The central computer system retrieves from storage information describing the object 110 to which the tag device 104 is attached, and transmits the information to the PED 102. The PED 102 receives the information and provides the information about the object 110 to the user. The information may include advertising materials in the form of text, audio, and/or video along with links for further details about the object 110. The user may also have the option to either add the object to a shopping cart or to a project list. The shopping cart may hold items the user wishes to purchase, and the project list may contain items the user wants to keep track of for potential purchase at a later time. The user may not be required to associate the object with either the shopping cart or the project list.

The PED 102 assigned to a user may provide a link to the user's shopping cart and/or project. The shopping cart and the project list may be edited at any time. Changes to the shopping cart or project list may include changing a quantity of an item in the shopping cart or deleting items in either list. Items may be moved between the two lists (e.g., depending on whether or not that item is kept in stock). In some embodiments, certain items may not be able to put placed into the shopping cart and may only be added to the project list due to their nature. For example, in the setting of a home building products and services facility, certain items may be sold on the premises, like lighting fixtures, furniture, etc., but other items may not be kept in storage, like bricks, paints, or siding. In addition, services that may be offered would be placed in the project list because they require further interaction between the user and the store before actually purchasing the service. Examples of such a service may include the installation of crown molding, a specific wall treatment, or a complete kitchen remodeling. Further interaction may be needed for such services due to scheduling the work, selection of details about their installation, etc.

Items and services that are ineligible for placement in the shopping cart may only be placed into the project list. For items that are not kept in storage, the PED 102 may provide the user with information regarding where they may be purchased or how they may be ordered. Services, on the other hand, may require a consultation with a representative of the home building products and services facility so that particulars, such as labor, price, scheduling, additional options, etc., can be discussed. These consultations may also be scheduled with the appropriate representative or department using the PED 102.

If a user scans the tag device 104 of an object 110 and the PED 102 determines the object 110 is out of stock, the PED 102 may not allow the object 110 to be placed into the shopping cart; only the project list may be available. In other embodiments of the method 800, the out of stock item may be placed in the shopping cart for purchasing on back order or to have the item shipped to the user's destination of choice.

In some embodiments, for example with regard to home building products and services, multiple objects 110 may be loaded into a shopping or project lists by physically scanning a single tag device 104. In such embodiments, a single tag device 104 may reference or otherwise identify a plurality of associated or grouped products. A tag device 104 that refers to a set of grouped items may be referred to as a “Just Like This” tag. For example, if a user visits a room 708 and likes all the objects in the room 708, the user can scan a tag device 702, which may be labeled, for example, “Just Like This Furniture.” Scanning the “Just Like This Furniture” tag 704 will cause the system 100 to provide to the user information about all objects 110 associated with that tag 704, e.g., a sofa, a love seat, an ottoman, two lamps, two end tables, and a rug. The PED 102 may then provide the option to move all of those items 110 into the shopping cart. However, the user may decide that less than all the items are currently desired and some of the items may be deleted or moved to the project list for later consideration.

A room 708 may also include a “Just Like This Finishings” tag device 702 associated with a group of objects or services that may only be placed into the project list, for example, the wall treatments, crown moldings, hardwood floors, etc. Upon scanning a “Just Like This Finishings” tag 702, the PED 102 may prompt the user with information regarding each item and service. The PED 102 may provide the option of moving all of the items and services into the project list, and scheduling a meeting with a service representative to discuss and schedule the work.

If presentation of stored information via the PED 102 fails to meet a user's needs, then the PED 102 may allow the user to contact a sales or customer service representative for additional assistance or information (e.g., by selecting a help icon). The additional assistance may be provided via a video chatting window on the screen of the PED 102. The representative may also determine the location of the PED 102 as described herein and travel to the location of the user to communicate in person.

In block 806, the user has finished browsing the objects 110, and has a number of options for managing the shopping cart and project list. If the user is satisfied with how the lists are arranged, the user may purchase all items in the shopping cart. The user may also move items around, change quantities, or even delete items. A user may move items to the project list from the shopping cart so they can keep track of what they like and to purchase at a later time. Items in the project list may be moved to the shopping cart for purchase where quantities may be changed before purchasing. However, items that are not kept in stock or unavailable services may not be moved to the shopping cart. Meetings with service representatives may also be scheduled.

For parties that associated their PEDs 102, shopping carts may be consolidated before purchasing to avoid any duplicate purchases. Project lists may also be consolidated. A user may move items into either the shopping cart or project list by browsing the establishment's offerings from the PED 102 without scanning the tag devices 104. Whether an individual or a party is purchasing items in a shopping cart, the PED 102 can charge the credit card account associated with a user, or the user may select to pay at a store counter with another card or cash. Once all lists are altered and items purchased, the PED 102 is returned to the issuing authority.

Upon returning the PED 102, the server 108 saves the user's ID and associated files (e.g., profile, shopping cart, project list, etc.). Saving the information may allow the user to access their individual shopping carts and project lists via the store's website using their user ID as a log-in. Thus, users can add to the shopping cart and the project list while viewing the store's website via the internet.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system for providing information about an object, comprising:
a first hand held device wirelessly coupled to a central computer system, and comprising:
a wireless radio frequency (RF) tag reader; and
a display panel;
a wireless RF tag attached to an object offered for sale, the wireless tag comprising an identifier for the object;
wherein the first hand held device is configured to:
wirelessly scan the wireless tag;
extract the identifier from information wirelessly received from the wireless tag via the wireless scan;
wirelessly communicate the identifier to the central computer system as part of a request for information concerning the object; and
upon receiving a response to the request for information, display the information concerning the object via the display panel.

2. The system of claim 1, wherein the wireless RF tag is one of an RF identification (RFID) chip and a near-field communication device.

3. The system of claim 1, wherein the information concerning the object comprises a textual specification of the object, audio files describing the object, video files describing the object, and a number of the object in stock available for purchase.

4. The system of claim 1, further comprising:
a plurality of wireless RF tags, each attached to an object;
wherein the central computer system stores a geographic location of each object; and
the central computer system is configured to determine location of the first hand held device based on the geographic location of a tag device last scanned by the first hand held device.

5. The system of claim 4, further comprising a plurality of wireless access points through which the first hand held device communicates with the central computer system, and wherein the central computer system is configured to:
identify the geographic location of a tag device last scanned by the first hand held device as being the location of the first hand held device based on the tag device last scanned being scanned by the first hand held device not more than a predetermined time prior to location determination; and
identify the location of the first hand held device based on strength of signals transmitted by the first hand held device and received at the access points based on the first hand held device having scanned no tag device not more than the predetermined time prior to location determination.

6. The system of claim 1, further comprising a group wireless RF tag that is attached to an object, and wherein the central computer system associates a group identifier stored in the group wireless tag with a plurality of different objects, and wherein the central computer system is configured to, on receipt of the group identifier from the handheld device:
identify the plurality of different objects identified by the group wireless tag;
transmit information for each of the different objects to the first hand held device.

7. The system of claim 6, wherein the plurality of different objects comprise objects located in a room where the group wireless tag is located.

8. The system of claim 1, further comprising a second hand held device wirelessly coupled to the central computer system, and comprising:
a wireless radio frequency (RF) tag reader; and
a display panel;
wherein the central computer system is configured to:
identify the first hand held device and the second hand held device as a unique group, and enable the first handheld device to:
access a shopping cart and a project list of the second hand held device;
copy items from the shopping cart and project list of the second hand held device; and
communicate audio-visually with second hand held device via a wireless network.

9. The system of claim 8, further comprising a third hand held device wirelessly coupled to the central computer system, and comprising:
a wireless radio frequency (RF) tag reader; and
a display panel;
wherein the third hand held device is configured to: instruct the central computer system to copy items from the shopping cart and project list of the second hand held device to the shopping cart and project list of the first hand held device.

10. A method for providing information, comprising:
attaching a wireless radio frequency (RF) tag to each of a plurality of objects;
scanning the wireless tag of one of the objects with a first hand held wireless device;
extracting an identifier from information received from the wireless tag via the scanning;
transmitting the identifier to a central computer system;
retrieving, in the central computer system, specifications of the one of the objects;
transmitting the specifications to the hand held wireless device; and
presenting the specifications for viewing on the hand held wireless device.

11. The method of claim 10, further comprising:
determining a geographic location of each of the objects; and
storing the geographic location at a location in the central computer system that is determinable using the identifier.

12. The method of claim 11, further comprising determining location of the first hand held device based on the geographic location of a tag device last scanned by the first hand held device based on the tag device last scanned being scanned by the first hand held device not more than a predetermined time prior to location determination.

13. The method of claim 12, further comprising determining location of the first hand held device based on strength of signals transmitted by the first hand held device and received at a plurality of access points based on the first hand held device not having scanned a tag device within the predetermined time prior to location determination.

14. The method of claim 10, further comprising:
associating, in the central computer system, a plurality of different objects with a group wireless tag attached to an object;
transmitting specifications of the plurality of different objects to the hand held wireless device responsive to reception of an identifier of the group wireless tag from the first hand held device.

15. The method of claim 14, wherein the plurality of different objects comprise related objects located in a room where the group wireless tag is located.

16. The method of claim 10, further comprising:
identifying, in the central computer system, the first hand held device and a second hand held device as a unique group, and via the first handheld device:
accessing a shopping cart and a project list of the second hand held device;
copying items from the shopping cart and project list of the second hand held device to the shopping cart and project list of the first hand held device; and
communicating audio-visually with second hand held device via a wireless network.

17. The method of claim 16, further comprising instructing, via a third hand held wireless device, the central computer system to copy items from the shopping cart and project list of the second hand held device to the shopping cart and project list of the first hand held device.

18. A non-transitory computer-readable medium encoded with instructions that when executed cause a processor to:
associate each of a plurality of objects with a wireless radio frequency tag attached to the object;
associate a geographic location of each of the objects with an identifier of the wireless tag attached to the object;
receive wireless tag identifiers from a hand held wireless device that scans the wireless tags; and
determine a location of the hand held device based on the geographic location associated with a wireless tag last scanned by the hand held device based on the wireless tag last scanned being scanned by the hand held device not more than a predetermined time prior to location determination.

19. The computer-readable medium of claim 18 encoded with instructions that when executed cause a processor to:
retrieve specification for one of the objects for which the identifier of a wireless tag is received from the hand held wireless device;
transmit the specifications to the hand held wireless device;
wherein the specifications comprising a textual specification of the object, audio files describing the object, video files describing the object, and a number of the object in stock available for purchase.

20. The computer-readable medium of claim 18 encoded with instructions that when executed cause a processor to:
identify, in the central computer system, the hand held wireless device and a different hand held device as a unique group;
enable the hand held wireless device to access a shopping cart and a project list of the different hand held device;
enable the hand held wireless device to copy items from the shopping cart and project list of the different hand held device to the shopping cart and project list of the hand held wireless device; and
enable audio-visual communication between the hand held wireless device and the different hand held device via a wireless network.
